(19) United States
(12) Patent Application Publication
(10) Pub. No.: US 2015/0309283 A1
(43) Pub. Date: Oct. 29, 2015

(54) AUXILIARY CAMERA LENS

(71) Applicant: LENSBABY, LLC, Portland, OR (US)

(72) Inventors: CRAIG C. STRONG, Portland, OR (US); YASSER ALIZADEH, Portland, OR (US)

(21) Appl. No.: 14/664,722

(22) Filed: Mar. 20, 2015

Related U.S. Application Data
(60) Provisional application No. 61/968,789, filed on Mar. 21, 2014.

(51) Int. Cl. G02B 13/00

(52) U.S. Cl. CPC G02B 13/005

(57) ABSTRACT

A lens assembly having a housing, an interior cavity, a first lens, and a second lens. The housing includes a reflective surface substantially covering at least a portion of an inner surface of the housing. The interior cavity is substantially surrounded by the inner surface of the tubular housing. The first lens extends across the first end of the housing, and it is configured to receive light from a scene outside of the lens assembly and refract the light into the interior cavity of the lens assembly. The second lens extends across the second end of the tubular housing, and it is configured to receive light from the interior cavity of the lens assembly and refract the light to a region outside of the lens assembly. Related methods are also disclosed.

### CROSS-REFERENCES TO RELATED APPLICATIONS

This patent application claims benefit from U.S. Provisional Application No. 61/968,789 filed Mar. 21, 2014, which is incorporated in its entirety by reference.

### FIELD OF THE INVENTION

This disclosure is directed to a camera lens, and, more particularly, to an auxiliary camera lens for use with digital cameras.

### BACKGROUND

Conventional cameras are ubiquitous, and they come in many shapes and sizes. In general, light enters a conventional camera through the camera's lens, where the light is refracted, or bent. In a conventional digital camera, the refracted light then strikes an image sensor. An image processor then interprets the information from the image sensor, converting that information into a digital image viewable by the user.

One current trend is to provide cameras with small lenses and sensors, for example, to incorporate such cameras into other devices. But such cameras do not always produce images having characteristics sought by the picture takers. As an example, depth of field is often difficult to achieve with a conventional small lens and small sensor.

The perception of depth in an image, including both still and moving images, is caused by producing an image that is sharp at a specific subject matter distance from the camera, and is gradually blurred in front of and/or behind that distance from the camera. The distance between the nearest and farthest areas of the image that are in focus is called depth of field. The depth of field may be shallow or wide. With a wide depth of field, most or all of an image is sharp. Thus, the image is flat, in that it does not convey a perception of depth. When depth of field is shallow or narrow, certain subject matter of an image is sharp, while the remainder of the image is blurred. This conveys a perception of depth to a viewer of an image. The depth of field in any image system is dependent on many factors, including sensor size, lens aperture size, and the focal length of the lens.

Cameras with large sensors used in conjunction with a large aperture lens, can normally produce images having a shallow depth of field. An example of a large sensor is the 43.2 mm diagonal measurement of a typical sensor for a single-lens reflex (SLR) camera.

Cameras with small sensors require relatively shorter focal length lenses with smaller diameter optics and smaller diameter apertures. An example of a small sensor is the 8.5 mm diagonal measurement of a typical sensor for a phone camera. The short focal length, smaller diameter optics, and smaller diameter aperture combine to reduce or eliminate the possibility of a shallow depth of field on most images produced by conventional camera phones and other conventional cameras with small sensors. Even so, such effects are desirable to many users.

Furthermore, conventional cameras allow a user only limited creative control over the final image. For example, conventional cameras do not allow users to add image embellishments, such as reflections or inserted patterns, to standard images as they are captured by the camera.

Accordingly, there are shortcomings with conventional systems. Embodiments of the disclosed subject matter address these and other issues in the prior art.

### SUMMARY OF THE DISCLOSURE

Embodiments of the invention are directed to a lens assembly that uses multiple optical elements to create the perception of shallow depth of field in images when placed in front of a camera with a small sensor, short focal length, and small apertures. In addition, some embodiments of the invention give users the option of introducing unique creative effects into their images using a reflective and/or transparent lens housing, or by using an intermediary focal plane.

Accordingly, at least some embodiments of a lens assembly include a housing, an interior cavity, a first lens, and a second lens. The housing includes a first end and a second end opposite the first end as well as a curved, reflective surface substantially covering at least a portion of an inner surface of the housing. The interior cavity is substantially surrounded by the inner surface of the tubular housing. The first lens extends across the first end of the housing, and it is configured to receive light from a scene outside of the lens assembly and refract the light into the interior cavity of the lens assembly. The second lens extends across the second end of the tubular housing, and it is configured to receive light from the interior cavity of the lens assembly and refract the light to a region outside of the lens assembly.

In at least some embodiments of the lens assembly, the housing is made of a flexible material, and the housing configured to temporarily deform under finger pressure applied by a user to an outer surface of the tubular housing.

In at least some embodiments of the lens assembly, the first lens and the second lens are configured to produce a focal point that is within the interior cavity and between the first lens and the second lens.

In at least some embodiments of the lens assembly, the first lens and the second lens are configured to produce a selective focus in an image.

In at least some embodiments of the lens assembly, the first lens includes an extension or window. In at least some embodiments, a lens element of the first lens is embedded in the extension, and the extension extends across the first end of the housing.

### BRIEF DESCRIPTION OF THE DRAWINGS

FIG. 1 is a cross-sectional view of a lens assembly connected to a camera, according to embodiments of the invention.

FIG. 2 is a cross-sectional view of a lens assembly that is in close proximity to a camera, according to embodiments.

FIGS. 3A, 3B, 3C, and 3D are, respectively, a perspective view, top view, side view, and bottom view of a lens assembly, according to embodiments.

FIG. 4 is a cross-sectional view of the lens assembly illustrated in FIG. 3C.

FIGS. 5A, 5B, 5C, and 5D are, respectively, a perspective view, top view, side view, and bottom view of a lens assembly, according to embodiments.

FIG. 6 is a cross-sectional view of the lens assembly illustrated in FIG. 5C.

FIG. 7A shows a sample photograph taken with a conventional camera. FIGS. 7B and 7C show sample photographs taken with a lens assembly, according to embodiments.

FIG. 8 is a sectional view of an embodiment of a lens assembly, according to embodiments.

FIG. 9A is a sectional view of a lens assembly with a flexible housing, shown in an un-flexed position, according to embodiments.

FIG. 9B is a sectional view of the embodiment of FIG. 9A in a flexed position.

FIG. 10A shows a sample photograph taken with a conventional camera.

FIGS. 10B and 10C show sample photographs taken with a lens assembly, according to embodiments.

FIG. 11 shows a cross-sectional view of a lens assembly, according to embodiments.

FIG. 12 is a sample photograph taken with a lens assembly, according to embodiments.

FIG. 13 is a functional diagram of an arrangement of lenses producing a focal plane between the lenses, according to embodiments.

### DETAILED DESCRIPTION

As described herein, embodiments of the invention are directed to an auxiliary camera lens. Some of the described embodiments provide an internally reflective housing, a selective focus feature to create the perception of shallow depth of field, and an intermediate focal plane at which other images and patterns may be inserted into an image to be captured by the camera. These features provide additional artistic control for a user of the auxiliary camera lens, allowing the user to create images that cannot be created with conventional camera lenses, particularly those camera lenses that are integrated with mobile devices.

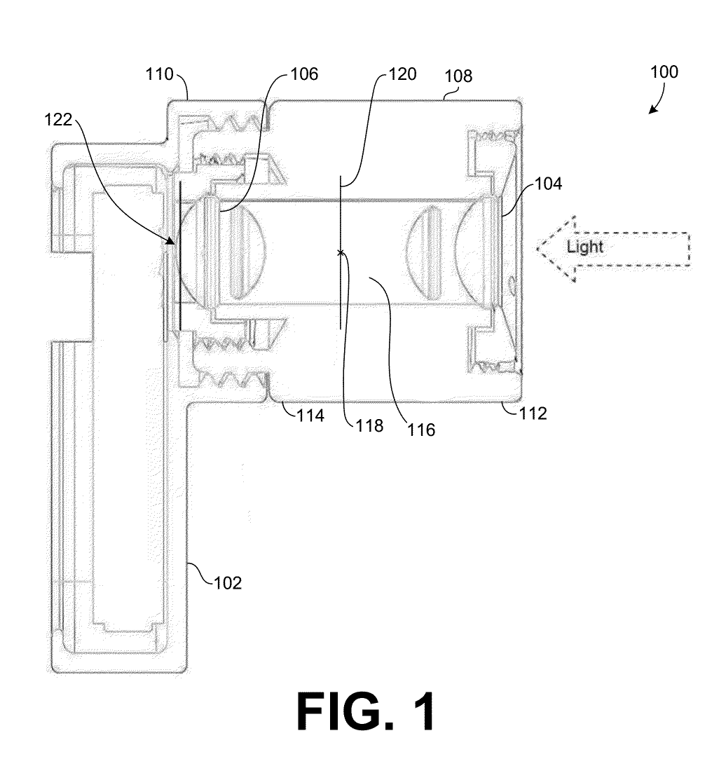

FIG. 1 is a sectional view of an embodiment of a lens assembly 100 connected to a camera 102. In embodiments, the lens assembly 100 includes a first lens 104, a second lens 106, and a housing 108. Some embodiments further include a mounting mechanism 110 to connect the lens assembly 100 to the camera 102. The camera 102 could be a stand-alone camera, such as a conventional film or digital point-and-shoot or single-lens reflex camera, or a camera integrated into another device, such as a mobile device, computer, or phone. The camera could be configured to take still photographs, video, or both.

In embodiments, the housing 108 is an elongated, tubular housing with a first end 112 and a second end 114 that is opposite the first end 112. The term “tubular” as used in this application means tubiform, without regard to cross-sectional shape. Thus, the tubular cross-section need not be round or rounded. In some embodiments, the housing 108 may be cylindrical, or it may be conical, or tapered, where one end is larger than the opposite end. In some embodiments, the housing 108 is not round and instead has relatively flat sides. The housing 108 may be made from materials that are rigid, semi-rigid, or flexible, and embodiments having a flexible housing are discussed more below. In embodiments, the housing 108 substantially surrounds an interior cavity 116.

In embodiments, such as shown in FIG. 1, the first lens 104 extends across a portion of the first end 112 of the housing 108, and the second lens 106 extends across a portion of the second end 114 of the housing 108. The first lens 104 is configured to receive light from a scene outside of the lens assembly 100 and refract the light into the interior cavity 116 of the lens assembly 100, while the second lens 106 is configured to receive light from the interior cavity 116 of the lens assembly 100 and refract the light to a region 122 outside of the lens assembly 100.

In embodiments, the first lens 104 may be a single lens element, or it may have two or more lens elements. Likewise, in embodiments, the second lens 106 may be a single lens element, or it may have two or more lens elements. The first lens 104 and the second lens 106 may be made from any suitable material, including low dispersion glass, high dispersion glass, or plastic, as examples. In embodiments, the first lens 104 and the second lens 106 may be flat, convex, concave, plano-convex, plano-concave, meniscus, bi-convex, equi-convex or spherical lenses. Other shapes are also contemplated. In some embodiments, the first lens 104 and the second lens 106 have the same shape. In other embodiments, the first lens 104 and the second lens 106 have different shapes. FIG. 1 shows a first lens 104 having two lens elements, each being a plano-convex lens element oriented in the same direction. Likewise, FIG. 1 shows a second lens 106 having two lens elements, each being a plano-convex lens element oriented in opposite directions. This is one example configuration, and other embodiments use different configurations.

In embodiments, the first lens 104 is configured to produce a focal point 118 that is within the interior cavity 116 and between the first lens 104 and the second lens 106. The focal plane 120 shown in FIG. 1, is a plane drawn through the focal point 118 of an embodiment and which is perpendicular to the optical axis of the first lens 104. For a lens that is symmetrical about its centerline, such as the first lens 104 depicted in FIG. 1, the optical axis and the focal point are each generally along the axis of that centerline.

As shown in FIG. 1, embodiments of the lens assembly 100 may be temporarily or permanently attached to the camera 102. For example, embodiments may include the mounting mechanism 110, which may include a corresponding mechanism on the camera 102. In some embodiments, the mounting mechanism 110 may be a threaded connecter receiver, such as shown in FIG. 1, or a bayonet mount. In some embodiments, the mounting mechanism 110 may be magnetic or hold the lens assembly 100 close to the camera 102 through friction. The mounting mechanism 110 may be made from any suitable material, such as plastic or metal. In some embodiments, the mounting mechanism 110 is made of aluminum.

Continuing to refer to an embodiment as depicted in FIG. 1, light enters the lens assembly 100 through the first lens 104, where the light is refracted into the interior cavity 116. The second lens 106 then receives the light from the interior cavity 116 of the lens assembly 100 and refracts the light to a region 122 outside of the lens assembly 100. In embodiments, that region 122 corresponds to a region just outside, and in front, of the lens of the camera 102, where the light may then pass into the camera 102. In embodiments, the distance between the second lens 106 and the lens of the camera 102 is set to provide a fixed amount of relief. In other embodiments, the distance between the second lens 106 and the lens of the camera 102 is adjustable and allows increased relief by a user increasing the distance and allows decreased relief by the user decreasing the distance. In this way, light travels through and is modified by the lens assembly 100 before passing into the camera 102, where the light may then be detected by the camera's film or image sensor.

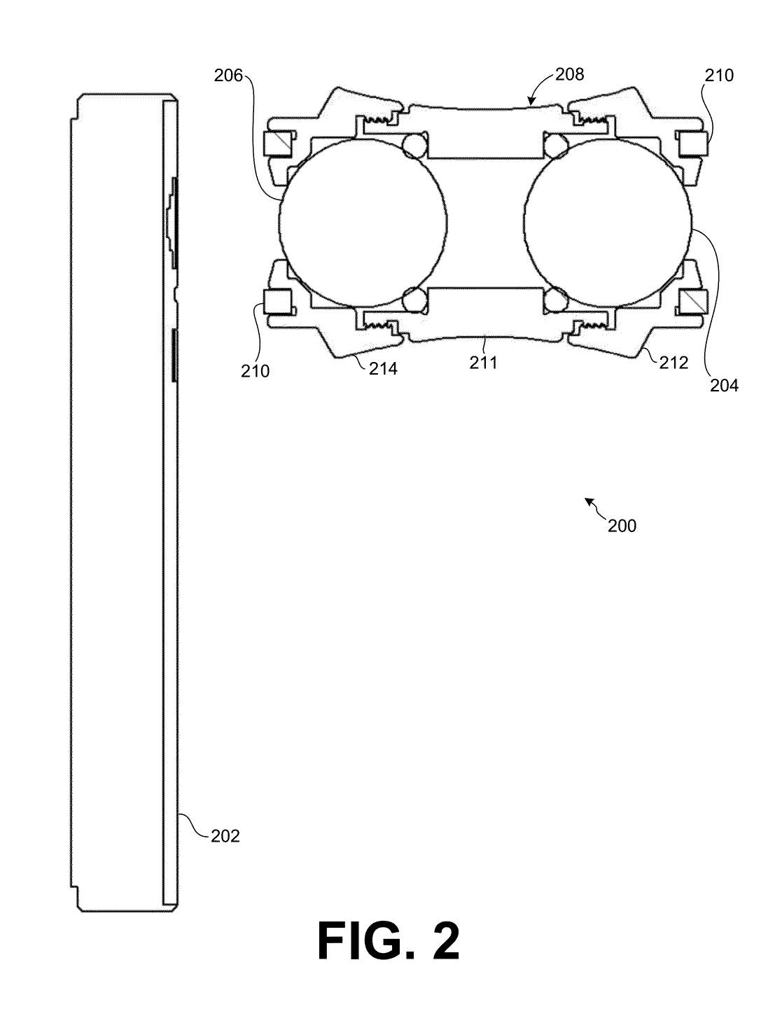

FIG. 2 is a cross-sectional view of an embodiment of a lens assembly 200 that is in relatively close proximity to a camera 202. In FIG. 2, the lens assembly 200 is not yet connected to the camera 202, although it is positioned and oriented to be connected. In embodiments, the lens assembly 200 includes a first lens 204, a second lens 206, a housing 208, and a mounting mechanism 210 to connect the lens assembly 200 to the camera 202. A corresponding mounting mechanism on the camera 202 is not illustrated in FIG. 2, but functions to receive the lens assembly 200 and maintain it in a fixed or adjustably-fixed relationship to the camera. Except as discussed here, the embodiment shown in FIG. 2 may have similar features as described for the embodiment of FIG. 1 above.

In embodiments, the first end 212 and the second end 214 of the housing 208 are removably connected to a base portion 211 of the housing 208 to facilitate installation and removal of the first lens 204 and the second lens 206. For example, the first end 212, the second end 214, or both may be threaded to the base portion 211, or they may be friction-fit. In some embodiments, the mounting mechanism 210 is a magnetic mount located at both the first end 212 and the second end 214 of the housing 208 to allow the lens assembly 200 to be mounted to the camera 202 from either end of the lens assembly 200.

In embodiments, such as shown in FIG. 2, the first lens 204 and the second lens 206 are equally-sized spherical lenses. In such embodiments, the focal length of the camera 202 is not significantly affected by the lens assembly 200. In some embodiments, the first lens 204 is larger than the second lens 206. In such embodiments, the focal length of the camera 202 is effectively increased by the addition of the lens assembly 200 to the camera 202. In some embodiments, the first lens 204 is smaller than the second lens 206. In such embodiments, the focal length of the camera 202 is effectively reduced by the addition of the lens assembly 200 to the camera 202.

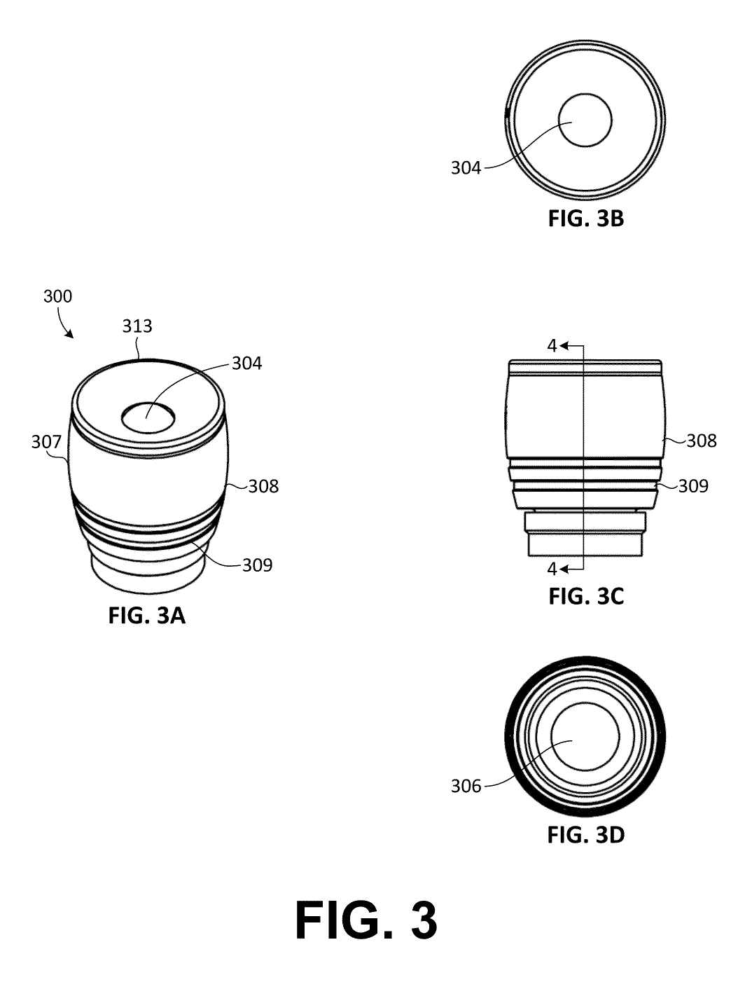

FIGS. 3A, 3B, 3C, and 3D illustrate a perspective view, top view, side view, and bottom view, respectively, of a lens assembly 300 according to embodiments of the invention. An outer surface 307 of the housing 308 may include ridges or recesses 309 for increased manipulability. In some embodiments, the ridges or recesses 309 may be wholly or partially for aesthetics. As shown in FIG. 3A, in some embodiments an area 313 near the first lens 304 is shaped to provide relief and an increased field of view. In embodiments, the area 313 flares outward, in tapered cone shape, from the first lens 304 to provide the relief.

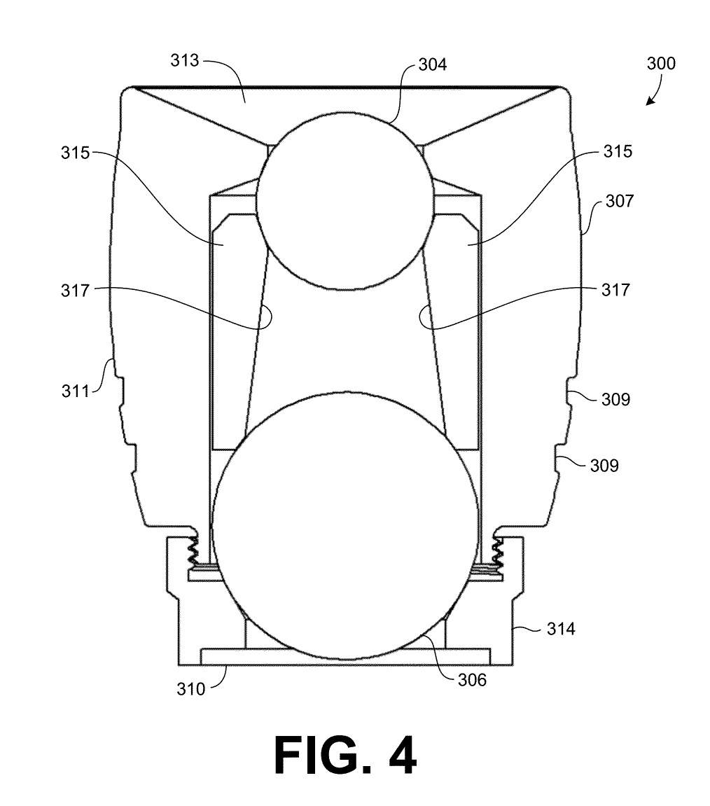

FIG. 4 is a cross-sectional view of the lens assembly 300 of FIG. 3C, showing further details of the assembly having ridges or recesses 309 on the housing 308 and a relief area 313. In some embodiments, such as shown in FIG. 4, a lens assembly 300 includes a first lens 304 that is substantially smaller than a second lens 306. As noted above, such a configuration effectively reduces the focal length of the camera to which the lens assembly 300 is attached. A mounting mechanism 310 is included in embodiments for mounting the lens assembly 300 to a camera.

Some embodiments, such as depicted in FIG. 4, include a spacer 315. In embodiments, the spacer 315 holds the first lens 304 away from the second lens 306 at a particular distance. In some embodiments, the spacer 315 may have a polished inside surface 317, which causes light to be internally reflected within the lens assembly 300 to produce artistic effects, as discussed in detail below. The inside surface 317 may be a surface of the spacer 315 itself, or the inside surface 317 may be a separate surface placed within or attached to the spacer 315. The spacer 315 may be made from metal, plastic, or another durable material. The inside surface 317 of the spacer 315 could be made from a polished glass tube; plastic; chrome plating; or a flexible, synthetic film, such as MYLAR® sheeting produced by DuPont Teijin Films. In embodiments, those materials could be clear, cloudy, or colored, each providing a different effect.

In embodiments, the second end 314 of the housing 308 may be threaded or otherwise removably connected to the base portion 311 of the housing 308. In such embodiments, the second end 314 may be removed to facilitate removal or installation of the second lens 306, the spacer 315, and the first lens 304.

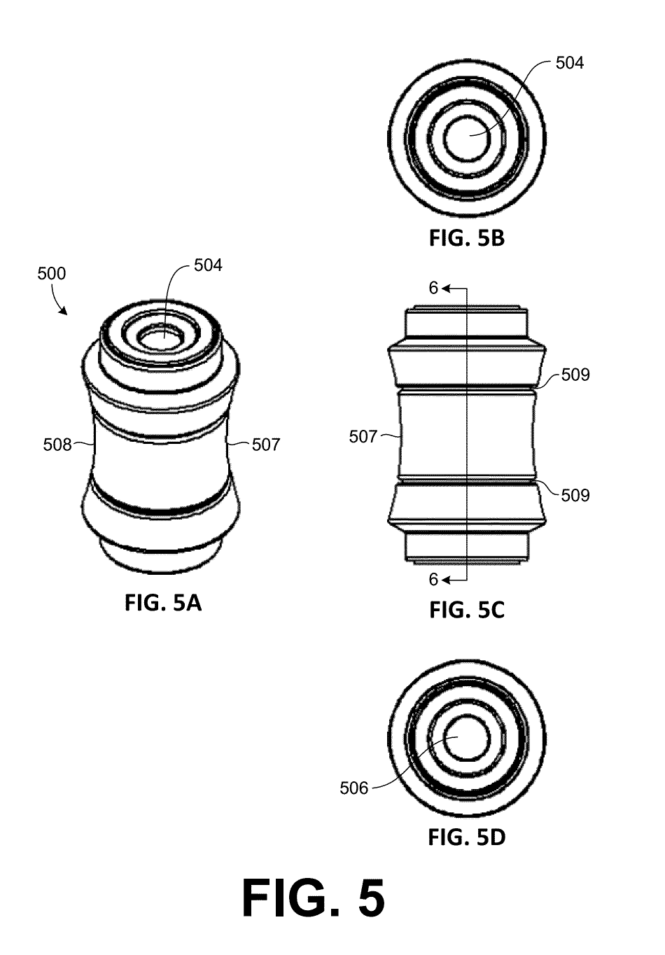

FIGS. 5A, 5B, 5C, and 5D illustrate a perspective view, top view, side view, and bottom view, respectively, of a lens assembly 500 according to embodiments of the invention. As in FIG. 3, the outer surface 507 of the housing 508 may include ridges or recesses 509 for increased manipulability, aesthetics, or both.

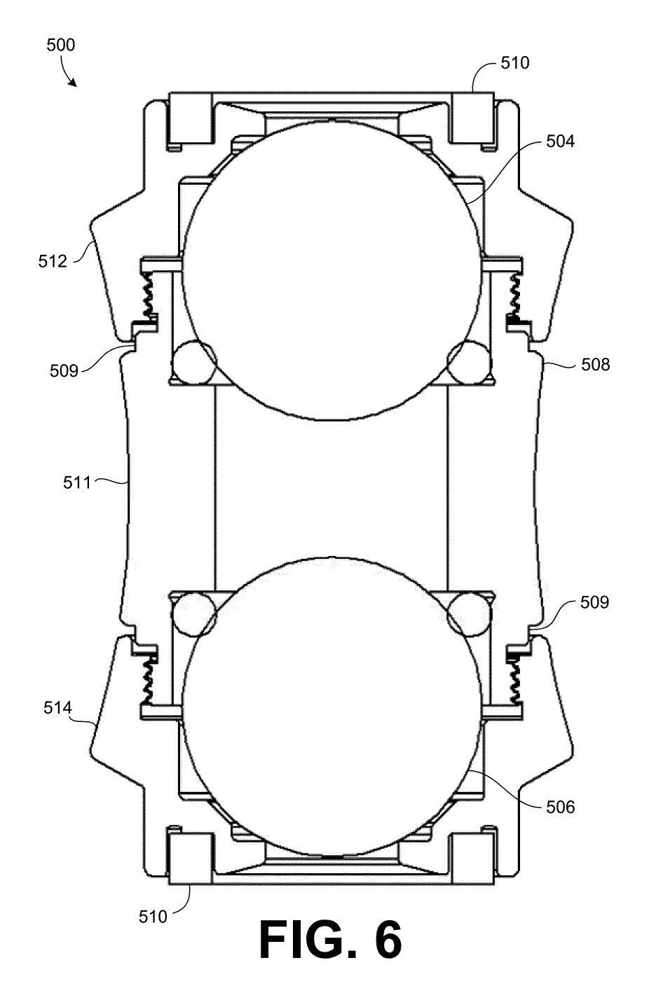

FIG. 6, is a cross-sectional view of FIG. 5C, showing further details of an embodiment of the lens assembly 500 in FIG. 5. In some embodiments, such as shown in FIG. 6, a lens assembly 500 includes a first lens 504 that is substantially the same size as a second lens 506. As noted above, such a configuration has no significant effect on the focal length of the camera to which the lens assembly 500 is attached. The mounting mechanism 510 is included in some embodiments, and the mounting mechanism 510 may be on both the first end 512 and the second end 514 of the housing 508 to allow the lens assembly 500 to be mounted to a camera from either end.

In embodiments, such as shown in FIG. 6, the first end 512 and the second end 514 of the housing 508 are removably connected to a base portion 511 of the housing 508.

In embodiments, the first lens 504 may be a spherical lens with a diameter of between about 6 mm to about 18 mm, preferably between about 10 mm and about 14 mm, and most preferably about 12 mm. In embodiments, the second lens 506 may be a spherical lens with a diameter of between about 6 mm to about 18 mm, preferably between about 10 mm and about 14 mm, and most preferably about 12 mm. At the closest point of their spherical surfaces, the first lens 504 and the second lens 506 may be spaced about 2 mm to about 12 mm apart, preferably about 4 mm to about 8 mm part, and most preferably about 5.5 mm apart, in embodiments.

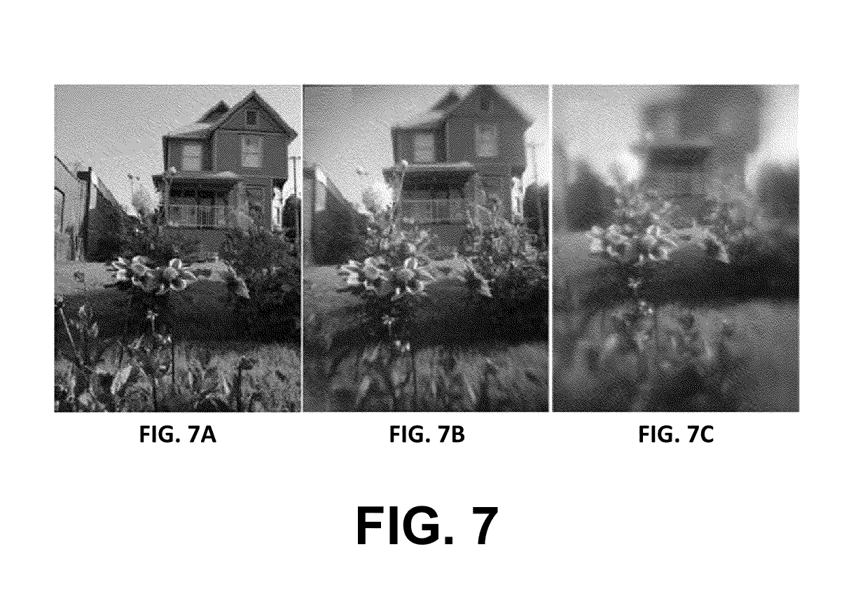

FIG. 7A shows a sample photograph taken with a conventional camera, such as a camera integrated into a smart phone or tablet computer. As shown in FIG. 7A, in photographs taken by a conventional camera, subject matter that is closer to the camera is typically just as sharp, i.e. in focus, as subject matter that is farther from the camera. Thus, the flowers in the foreground of FIG. 7A are in focus, and the house that is farther from the camera is also in focus.

In embodiments of the lens assembly, the focused area of the image could form a “spot of focus” or a “slice of focus.” A “spot of focus” is a generally round portion of the image that is sharp, while the remaining part of the image is less sharp or blurry. Similarly, a “slice of focus” is a generally rectangular portion of the image that is sharp, while the remaining part of the image is less sharp or blurry. Typically, the rectangular portion extends from one edge to an opposite edge of an image. The slice of focus and spot of focus features are sometimes referred to as “selective focus” in this application. Whether an image includes selective focus is a function of the type and geometry, including the positioning and spacing, of the lens elements used in the first lens and the second lens. For example, if the first lens, the second lens, or both is a cylindrical lens, then the resulting image has a slice of focus on the image. As another example, a spot of focus may be achieved in embodiments in which the first lens, the second lens, or both focus an image in a curved field of focus, i.e. field curvature, have astigmatism, or include spherical aberrations. Other configurations are also possible. Thus, an image with a spot of focus may have a sharp image along the axis of the optical system, and decreasing sharpness when departing from the axis radially. In some embodiments, the spot of focus results from a combination of field curvature, astigmatism, and spherical aberrations. In embodiments, the field curvature may be the predominant component in a combination with astigmatism or spherical aberration, or any combination thereof. For example, in embodiments the field curvature may be sixty percent or more of the combination with astigmatism or spherical aberration or both.

In embodiments with selective focus, the area of focus may be at the center of the image, or the area of focus may be anywhere else in the image. In each case, the area of focus is sharp, while the surrounding portions of the image are less sharp or blurry.

The size of the sharp area of focus is based on the effective focal length of the camera, including any influence from the lens assembly as discussed above, and the spacing of the first lens from the second lens. In some embodiments, the spacing between the first lens and the second lens is static. In some such embodiments, that spacing could be selected and pre-set for a specific application or for a particular camera. In other embodiments, the spacing between the first lens and the second lens is adjustable by the user. For example, embodiments could include a moving mechanism controlled by the user, where the mechanism increases or decreases the spacing between the first lens and the second lens.

Thus, in contrast to FIG. 7A, FIGS. 7B and 7C show sample photographs taken with embodiments of a lens assembly having selective focus. The image in FIG. 7C has a relatively smaller spot of focus than the image in FIG. 7B. Accordingly, the image in FIG. 7C has more blur in the image and a smaller sharp portion.

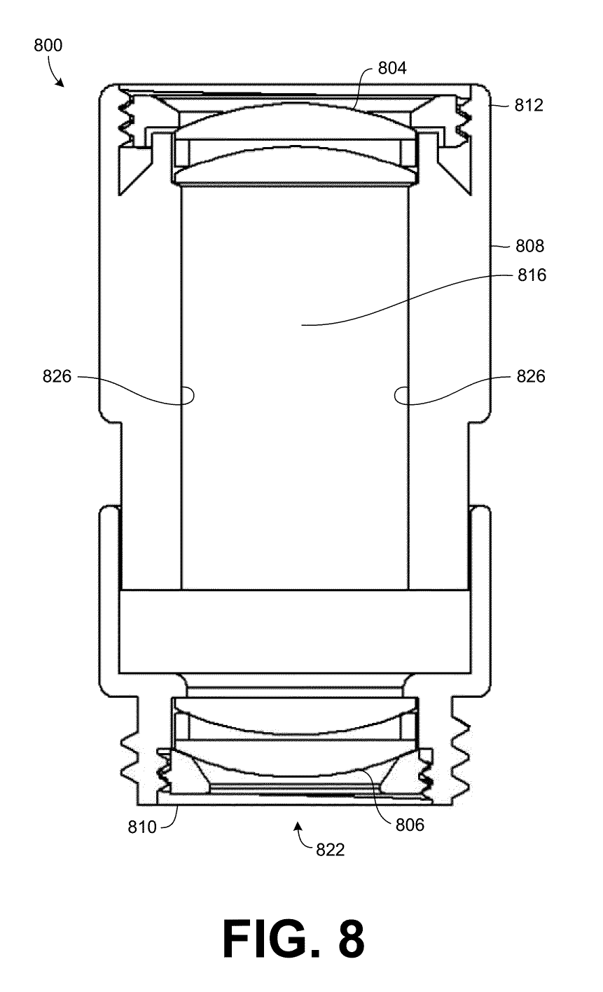

FIG. 8 shows a sectional view of an embodiment of a lens assembly 800 having a reflective housing. In embodiments, the lens assembly 800 includes a first lens 804, a second lens 806, a housing 808, and a mounting mechanism 810. In embodiments, the housing 808 has a first end 812 and a second end 814 that is opposite the first end 812, and the lens assembly 800 includes an interior cavity 816 that is substantially surrounded by an inner surface 826 of the housing 808. These features are generally as described above for other embodiments.

While FIG. 8 shows two lens elements for each of the first lens 804 and the second lens 806, as noted above, each of the first lens 804 and the second lens 806 may be a single lens element, or each may have two or more lens elements.

In certain embodiments, the housing 808 includes a reflective surface substantially covering at least a portion of an inner surface 826 of the housing 808. In embodiments, the reflective surface substantially covers the inner surface 826 of the housing 808. The reflective surface may be a surface of the housing 808 itself, or the reflective surface may be a separate surface placed within or attached to the inner surface 826 of the housing 808.

In some embodiments, the reflective surface is curved. In other embodiments, the reflective surface has facets. The reflective surface is conical or funnel-shaped in some embodiments, including embodiments in which the reflective surface is curved or faceted. In some embodiments the funnel or cone is non-linear, such that the shape of the funnel or cone is dictated by a curve rotated about the centerline of the funnel or cone. In some such embodiments, the curve has a varying curvature. In such embodiments, the funnel or cone appears to bulge or indent at one or more locations along the funnel or cone.

As light enters the interior cavity 816 of the lens assembly 800 after being refracted by the first lens 804, at least a portion of the light is reflected off of the reflective surface. In some embodiments, the light is reflected off of the reflective surface more than once. Then, the second lens 806 receives the light, some of which is surface-reflected light, from the interior cavity 816 of the lens assembly 800 and refracts the light to a region 822 outside of the lens assembly 800, where the light may pass into the camera. In this way, the reflected light from the reflective surface creates a mirroring effect in an image captured by a camera connected to the lens assembly 800.

The extent of the mirroring effect depends on the reflectivity of the inner surface 826. The reflectivity may be influenced by the relative amount of the inner surface 826 of the housing 808 that is reflective, as well as the materials used to make the reflective surface. Reflectivity may also be influenced by the surface finish of the reflective surface 826. For example, the reflective surface could be made from a polished glass tube; plastic; chrome plating; or a flexible, synthetic film, such as MYLAR® sheeting produced by DuPont Teijin Films. Each of these materials could be clear, cloudy, or colored. Because these materials have different indexes of reflectivity, the materials cause slightly or substantially different mirroring effects in the image captured by the camera. For example, chrome plating is generally more reflective than colored plastic.

In some embodiments, the housing 808 is substantially transparent. The transparent housing 808 could also be used to generate an effect similar to a semi-reflective material, while also allowing movement effects. When comparted to a reflective housing, a transparent housing typically reflects a smaller percentage of the light rays. This yields a normal central image, with an overlay of mirrored reflection with less contrast.

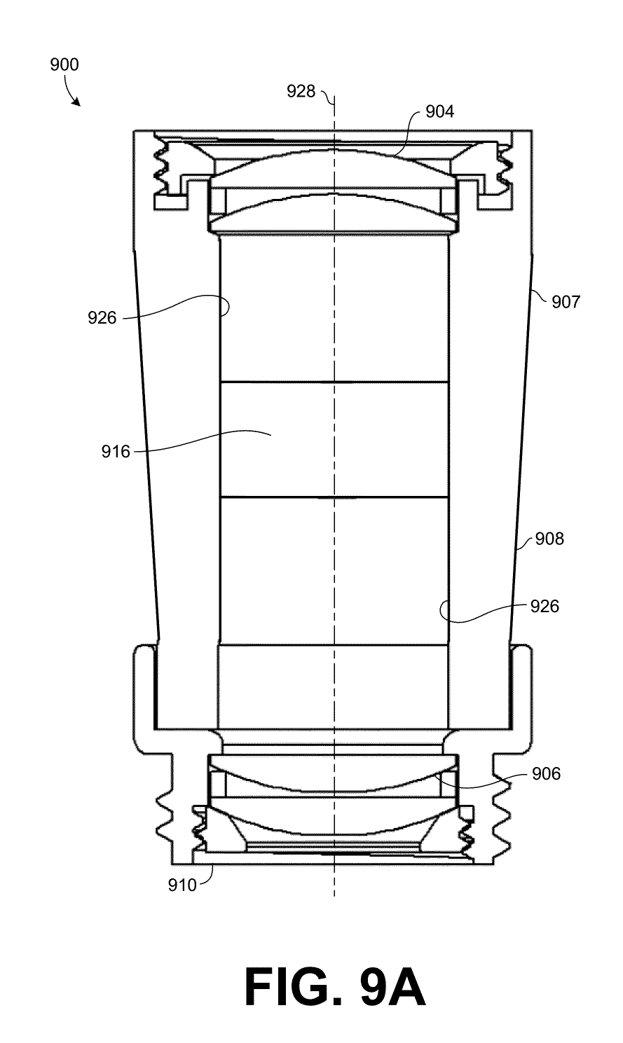

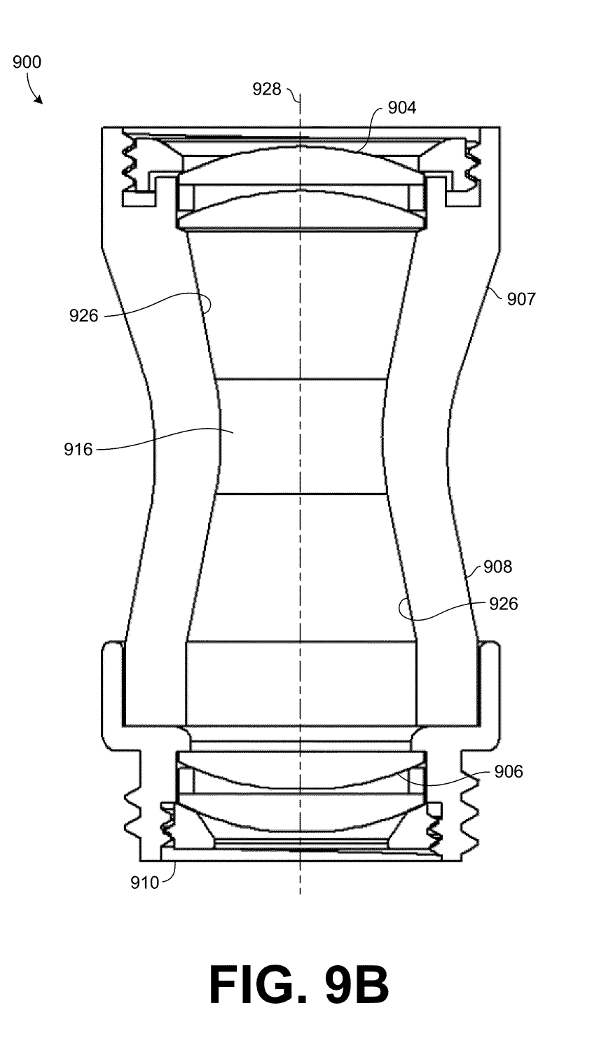

FIG. 9A shows an embodiment of a lens assembly 900 with a flexible housing 908, shown in an un-flexed or non-flexed position. The embodiment shown in FIG. 9A generally has the same features as the embodiment shown in FIG. 8, including a first lens 904, a second lens 906, a housing 908, a mounting mechanism 910, an interior cavity 916, and an inner surface 926. In embodiments, the housing 908 includes a reflective surface substantially covering at least a portion of the inner surface 926 of the housing 908, such as described above for FIG. 8.

In embodiments, the housing 908 is made from a resilient or flexible material, allowing the housing 908 to deform to a flexed position when an outside force acts on the housing. In some embodiments, the housing 908 is configured to temporarily deform under force, such as finger pressure or manual squeezing, applied by a user to an outer surface 907 of the housing 908. In embodiments, the housing 908 may elastically return to its original, un-flexed shape once the force is removed. In other embodiments, the housing 908 will not return to its un-flexed shape unless an additional force is applied to reshape the housing 908. In embodiments, the resilient or flexible material can be rubber; synthetic rubber; or a flexible, synthetic film, such as MYLAR® sheeting produced by DuPont Teijin Films.

FIG. 9B shows the embodiment of FIG. 9A in a flexed position, after the housing 908 has been deformed from its pre-flexed shape. While FIG. 9B shows the housing 908 as being crimped or indented along its midline, the deformation could be anywhere along the housing 908. In embodiments, the deformation is symmetrical about a longitudinal axis 928 of the housing 908. In other embodiments, the deformation is asymmetrical about the longitudinal axis 928 of the housing 908. In some embodiments, the portion of the housing 908 that will most readily deform is pre-determined by the manufacturer during the manufacturing process. For example, some portions of the housing 908 may be thinner than others, or may be further processed to remove a portion of the housing material in certain sections. In this way the manufacturer can pre-determine or pre-set the area of flex of the housing 908, causing pre-determined effects.

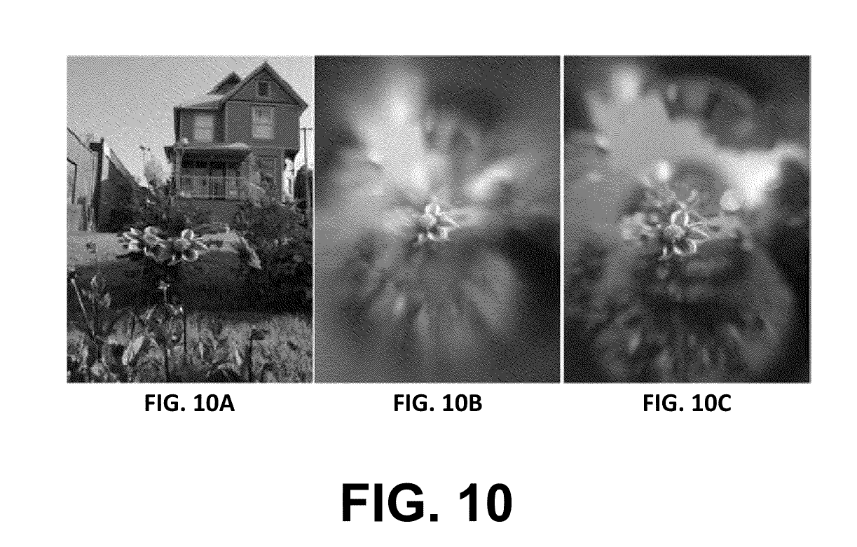

FIG. 10A shows a sample photograph taken with a conventional camera, in which the subject matter of the photograph does not include any reflected images. Accordingly, the photographic image appears substantially the same as the scene would to a human observer of the scene. In contrast to FIG. 10A, FIGS. 10B and 10C show sample photographs taken with embodiments of a lens assembly having a reflective surface substantially covering at least a portion of the inner surface of the housing. FIGS. 10B and 10C show different levels of reflectivity created in the images, with the level of reflectivity in FIG. 10B being greater than the level of reflectivity in FIG. 10C.

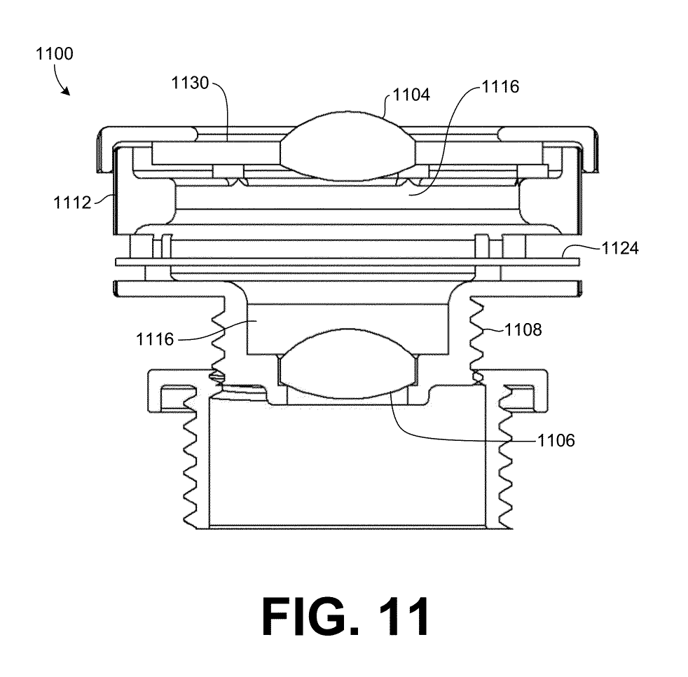

FIG. 11 shows a sectional view of an embodiment of a lens assembly 1100 that includes an image insert or frame 1124 at the focal plane. As noted above, the focal plane is a plane drawn through the focal point of an embodiment and which is perpendicular to the optical axis of the first lens 1104. In embodiments, the lens assembly 1100 includes a first lens 1104, a second lens 1106, a housing 1108, and an interior cavity 1116. These features are generally as described above for other embodiments.

In embodiments, the lens assembly 1100 also includes a frame 1124 with a transparent material substantially coinciding with the focal plane. For example, a rigid or semi-rigid frame 1124 may hold a piece of film or a transparency at the focal plane. In some embodiments, the frame 1124 may be a translucent liquid crystal display (LCD) panel. The frame 1124 is removable and replaceable in embodiments. In such embodiments the frame 1124 may be held in a receiver within the lens assembly 1100. Such a receiver may include a slot, opening, or cavity. The receiver may additionally include a retention mechanism structured to hold the frame 1124 in place after it is inserted into the lens assembly 1100. In other embodiments, the frame 1124 is permanently mounted within the housing 1108. In embodiments, the frame 1124 depicts a pattern. In embodiments, the pattern may be a secondary image, such as a photographic image, slide, or negative; a line drawing; a shape; a tint or color; or another decorative design.

In embodiments having a frame 1124, light that has been refracted by the first lens 1104 into the interior cavity 1116 passes through the frame 1124. As the light passes through the frame 1124, the light is modified by and picks up the pattern of the frame 1124 before the second lens 1106 refracts the light to the region outside of the lens assembly 1100, where the light may pass into a camera connected to the lens assembly 1100. In this way, the camera's sensor or film senses or “sees” both the original scene received by the first lens 1104 and the pattern introduced to the scene by the frame 1124.

In some embodiments, the lens assembly 1100 includes an extension or window 1130. In embodiments, such as shown in FIG. 11, the window 1130 extends across a portion of the first end 1112 of the housing 1108. In embodiments, window 1100 is made from plastic or glass. In embodiments, window 1100 is integrated with first lens 1104. In such embodiments, first lens 1104 may be embedded in window 1100. In other embodiments, window 1100 is separate from first lens 1104, in that they are different pieces. In embodiments, the window 1130 may be clear, tinted, or included shapes or patterns to add effects to an image captured by the camera. In some embodiments, window 1130 provides a larger field of view than what first lens 1112 would provide without window 1130.

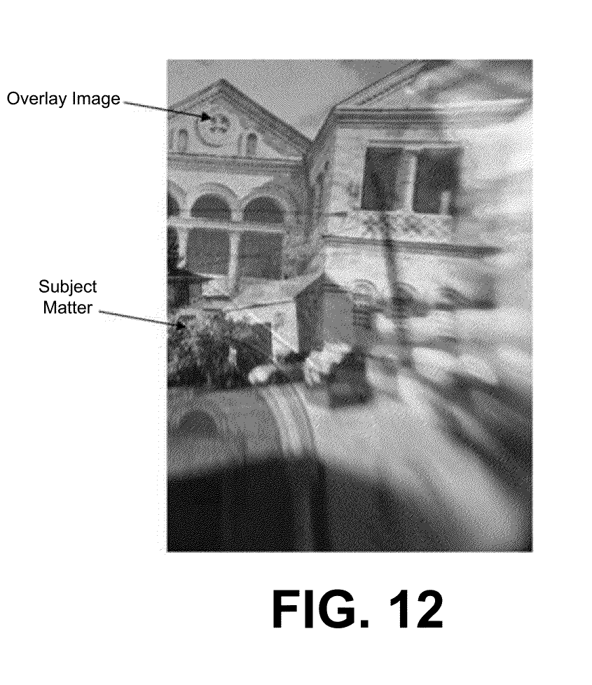

FIG. 12 is a sample photograph taken with an embodiment of a lens assembly having a frame at the focal plane. In FIG. 12, an image of a columned building is overlaid onto an image of a shed surrounded by bushes. In this example, the image of the columned building was depicted on the frame inserted into the housing, and the image of the shed surrounded by bushes was the scene captured by the first lens.

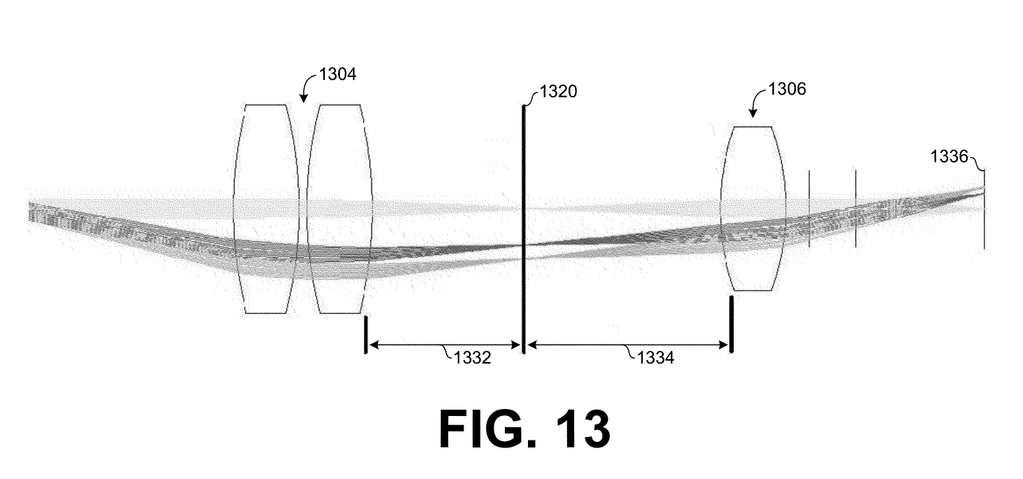

FIG. 13 is a functional diagram of an arrangement of lenses producing a focal plane between the lenses, according to embodiments. The focal plane 1320 depicted in FIG. 13 is between the first lens 1304 and the second lens 1306. FIG. 13 shows a first lens 1304 having two lens elements, each being an equi-convex lens element, and FIG. 13 shows a second lens 1306 having a single equi-convex lens element. This is one example configuration, and other embodiments use different configurations. The first lens 1304 has a back focal length 1332, which is the distance from the back edge, or back optical surface, of the first lens 1304 to the focal plane 1320. The second lens 1306 has a front focal length 1334, which is the distance from the focal plane 1320 to the front edge, or front optical surface, of the second lens 1304. The camera's sensor 1336 is beyond the second lens 1306.

With reference to FIG. 13, light enters the optical system from the left side of the figure, passes through the first lens 1304, and then passes through the second lens 1306 before striking the camera sensor 1336.

As shown in FIG. 13, one way to produce a focal plane between the lenses is where the first lens 1304 and the second lens 1306 are spaced apart by a distance essentially equal to the sum of the back focal length 1332 of the first lens 1304 and the front focal length 1334 of the second lens 1306.

The previously described versions of the disclosed subject matter have many advantages, including providing an internally reflective housing, a selective focus feature to create the perception of shallow depth of field, and an intermediate focal plane at which other images and patterns may be inserted into an image to be captured by the camera. Even so, all of these advantages or features are not required in all versions of the disclosed apparatuses and methods. Moreover, the features described above may be used singularly or in concert with any other features and also in conjunction with traditional accessory lenses such as wide angle, fisheye, telephoto and etc. to provide different results.

Although specific embodiments of the invention have been illustrated and described for purposes if illustration, it will be understood that various modifications may be made without departing from the spirit and scope of the invention. Accordingly, the invention should not be limited except as by the appended claims.

What is claimed is:

1. A lens assembly comprising:
an elongated, tubular housing including a first end and a second end opposite the first end;
an interior cavity within the elongated, tubular housing;
a reflective surface covering at least a portion of an inner surface of the interior cavity and configured to reflect light received from the interior cavity back into the interior cavity;
a first lens extending across a portion of the first end of the tubular housing, the first lens configured to receive light from a scene outside of the lens assembly and to refract the outside light into the interior cavity of the lens assembly; and
a second lens extending across a portion of the second end of the tubular housing, the second lens configured to receive light from the interior cavity of the lens assembly and to refract the inside light to a region outside of the lens assembly.

2. The lens assembly of claim 1, in which the reflective surface substantially covers the inner surface of the tubular housing.

3. The lens assembly of claim 1, in which the tubular housing comprises a flexible material, the tubular housing configured to temporarily deform under manual pressure applied by a user to an outer surface of the tubular housing.

4. The lens assembly of claim 1, in which the first lens and the second lens are spaced apart by a distance substantially equal to a sum of a back focal length of the first lens plus a front focal length of the second lens.

5. The lens assembly of claim 1, in which the first lens and the second lens are configured to produce a selective focus in an image based on one or more of field curvature, astigmatism, and spherical aberration of the first lens or the second lens.

6. The lens assembly of claim 1, in which the first lens comprises a clear, flat extension, in which a lens element of the first lens is embedded in the extension, and in which the extension extends across the first end of the housing.

7. The lens assembly of claim 1, further comprising a spacer within the tubular housing and between the first lens and the second lens, the spacer maintaining the first lens away from the second lens at a pre-set distance.

8. The lens assembly of claim 7, in which the spacer further comprises a reflective inner surface, and in which the reflective inner surface of the spacer is configured to reflect light received from the interior cavity back into the interior cavity.

9. The lens assembly of claim 3, further comprising a spacer within the housing and between the first lens and the second lens, the spacer holding the first lens away from the second lens at a pre-set distance, and in which:
the first lens and the second lens are spaced apart by a distance substantially equal to a sum of a back focal length of the first lens plus a front focal length of the second lens;
the first lens and the second lens are configured to produce a selective focus in an image, the first lens and the second lens having a combination of field curvature, astigmatism, and spherical aberration; and
the first lens further comprises a clear, flat extension, in which a lens element of the first lens is embedded in the extension, and in which the extension extends across the first end of the housing.

10. The lens assembly of claim 1, in which the first lens and the second lens are fixed focus lenses.

11. An accessory lens for a camera on a mobile device comprising:
a housing including a first end and a second end opposite the first end;
an interior cavity substantially surrounded by the housing;
a first lens at the first end of the housing, the first lens configured to receive light from a scene outside of the accessory lens and refract the outside light into the interior cavity of the accessory lens, the first lens having a back focal length; and
a second lens at the second end of the housing, the second lens configured to receive light from the interior cavity of the accessory lens and refract the interior light to a region outside of the accessory lens, the second lens having a front focal length, the second lens being separated from the first lens by a distance substantially equal to a sum of the back focal length of the first lens plus the front focal length of the second lens.

12. The accessory lens of claim 11, further adapted to receive a frame at a focal plane common to both the first lens and the second lens.

13. The accessory lens of claim 12, in which the accessory lens further comprises a receiver configured to accept the frame within the housing.

14. The accessory lens of claim 12, in which the frame includes a pattern.

15. The accessory lens of claim 14, in which the frame comprises a transparent film imprinted with the pattern.

16. The accessory lens of claim 14, in which the frame comprises a translucent liquid crystal display (LCD) displaying the pattern.

17. The accessory lens of claim 11, in which the housing comprises a resilient material, the housing configured to deform when manual pressure is applied by a user to an outer surface of the housing.

18. The accessory lens of claim 11, in which the first lens and the second lens are configured to produce a selective focus in an image caused by one or more of field curvature, astigmatism, and spherical aberration of the first lens and the second lens.

19. The accessory lens of claim 11, in which at least a portion of the housing is substantially transparent.

20. The accessory lens of claim 11, the first lens further comprising a transverse window, in which a lens element of the first lens is embedded in the window, and in which the window extends across a portion of the first end of the housing.

21. The accessory lens of claim 11, in which the first lens and the second lens each comprise a spherical lens.

22. The accessory lens of claim 1, in which the first lens and the second lens are fixed focus lenses.

23. A lens assembly comprising:
an elongated, tubular housing including a first end and a second end opposite the first end;
an interior cavity within the elongated, tubular housing;
a first lens extending across a portion of the first end of the tubular housing, the first lens configured to receive light from a scene outside of the lens assembly and to refract the outside light into the interior cavity of the lens assembly; and
a second lens extending across a portion of the second end of the tubular housing, the second lens configured to receive light from the interior cavity of the lens assembly and to refract the inside light to a region outside of the lens assembly;
in which the first lens and the second lens are configured to produce a selective focus in an image based on one or more of field curvature, astigmatism, and spherical aberration of the first lens or the second lens.

24. The lens assembly of claim 23, in which the first lens and the second lens are spaced apart by a distance substantially equal to a sum of a back focal length of the first lens plus a front focal length of the second lens.
